(19) United States
(12) Patent Application Publication
(10) Pub. No.: US 2017/0346708 A1
(43) Pub. Date: Nov. 30, 2017

(54) CHANNEL QUALITY ASSESSMENT FOR A DATA LINK GROUP

(71) Applicant: QUALCOMM Incorporated, San Diego, CA (US)

(72) Inventors: Abhishek Pramod PATIL, San Diego, CA (US); George CHERIAN, San Diego, CA (US); Santosh Paul ABRAHAM, San Diego, CA (US); Abhijeet BISAIN, San Diego, CA (US); Xiaolong LI, San Diego, CA (US); Ajay VUNDYALA, San Diego, CA (US)

(21) Appl. No.: 15/480,231

(22) Filed: Apr. 5, 2017

Related U.S. Application Data
(60) Provisional application No. 62/342,097, filed on May 26, 2016.

(51) Int. Cl. H04L 12/26; H04W 72/00; H04W 88/02

(52) U.S. Cl. CPC H04L 43/0817; H04W 72/005; H04L 43/16; H04W 88/02

(57) ABSTRACT

A device for wireless communication includes a receiver configured to receive first usage data of a channel of a data link group. The first usage data is received from a device of the data link group and is associated with a time period. The device also includes a processor configured to determine second usage data of the channel that is associated with the time period and to determine an unusable channel time value of the channel based on the first usage data and the second usage data.

### I. CROSS-REFERENCE TO RELATED APPLICATIONS

The present application claims benefit of U.S. Provisional Patent Application No. 62/342,097, filed May 26, 2016, entitled “CHANNEL QUALITY ASSESSMENT FOR A DATA LINK GROUP,” which is incorporated by reference in its entirety.

### II. FIELD

The present disclosure is generally related to channel quality assessment.

### III. DESCRIPTION OF RELATED ART

Devices included in a data link group of a neighbor aware network (NAN) or a wireless mesh network may be synchronized to wake up and exchange data. For example, data may be exchanged between multiple devices during time-frequency blocks spanning different channels. The devices of a data link group (or a wireless mesh) may change a schedule according to which the data is communicated. For example, the devices of the data link group may change a channel, change a time-block (TB) duration (TB_{size}), change a number of time-blocks, schedule time-blocks on different channels, or a combination thereof. To illustrate, if there is a conflict due to multiple data link groups (of the NAN) using the same combination of time-block and channel, one or more devices of one of the data link groups can assess a channel and determine whether the channel can support a service provided by the data link group. If the service cannot be supported by the channel, the service can be moved to another channel. Alternatively, time-blocks can be broken up across multiple channels.

One way to determine that a channel is unacceptable for use in providing a service is to examine an Unusable Channel Time (UCT) of the channel. The “unusability” of a channel is an amount of time the channel is used by someone else (e.g., devices of another network, such as another NDL network, an access point network, a mesh network, etc.). For example, Unusable Channel Time=Total Channel Utilization−NDL Channel Time, where Total Channel Utilization is an amount of time the channel is sensed as busy. A channel may be sensed as busy due to a data link group addressed transmission or due to a non-data link group addressed transmission (i.e., a broadcast message or a message addressed to another data link group).

In a data link group, since each device can independently form link(s) with any other device in the data link group, it may be difficult for a single device to acquire a complete view of all data link group traffic without receiving channel utilization data (e.g., transmission statistical data and/or reception statistical data) from other devices in the data link group. In contrast, in networks such as an Infra network or a Wi-Fi Direct network, an access point (AP) or a group owner (GO) has knowledge of the channel utilization of its network since all the traffic goes through the AP or the GO.

To determine whether a channel can support a service (e.g., quality of service (QoS) requirements of the service or the data link group), a device of a data link group may need to collect utilization data (e.g., channel load data, receive usage data, transmit usage data) from one or more other device of the data link group. Such data collection can be difficult and can add to communication overhead, because the data is not necessarily routed through a single device, such as an access point, which can collect data and determine channel QoS or channel availability. Additionally, to obtain information about another channel, a device of the data link group may scan the channel. To scan a channel, the device may dwell (e.g., monitor) a channel for long periods of time, which may interrupt data link group operations on an existing channel. Alternatively, a device may scan a channel between time-blocks of the data link group, which may be an insufficient amount of time to determine an availability of the channel.

### IV. SUMMARY

In a particular aspect, a device includes a receiver configured to receive first usage data of a channel of a data link group. The first usage data is received from a device of the data link group and is associated with a time period. The device also includes a processor configured to determine second usage data of the channel and associated with the time period and to determine an unusable channel time value of the channel based on the first usage data and the second usage data.

In another particular aspect, a method includes determining first usage data at a first device of a data link group. The first usage data corresponds to a channel of the data link group and is associated with a time period. The method further includes receiving, at the first device from a second device of the data link group, second usage data of the channel of the data link group. The second usage data is associated with the time period. The method also includes determining an unusable channel time value of the channel based on the first usage data and the second usage data.

In a particular aspect, a computer-readable storage device storing instructions that, when executed by a processor, cause the processor to perform operations including determining, at a first device of a data link group, first usage data of a channel of the data link group. The first usage data is associated with a time period. The operations further include identifying second usage data of the channel of a data link group. The second usage data is received at the first device from a second device of the data link group and is associated with the time period. The operations also include determining an unusable channel time value of the channel based on the first usage data and the second usage data.

In another particular aspect, an apparatus includes means for determining first usage data at a first device of a data link group. The first usage data corresponds to a channel of the data link group and is associated with a time period. The apparatus further includes means for receiving second usage data from a second device of the data link group. The second usage data corresponds to the channel of the data link group and is associated with the time period. The apparatus also includes means for determining an unusable channel time value of the channel based on the first usage data and the second usage data.

In another particular aspect, a device includes a receiver configured to receive first usage data of a channel of a data link group responsive to a query sent to a second device. The first usage data is associated with a time period. The device further includes a processor configured to determine second usage data of the channel that is associated with the time period and to determine an unusable channel time value of the channel based on the first usage data and the second usage data.

In another particular aspect, a method includes determining, at a first device of a data link group, first usage data of a channel of the data link group. The first usage data is associated with a time period. The method further includes, responsive to a query sent to a second device of the data link group, receiving, at the first device from the second device, second usage data of the channel. The second usage data is associated with the time period. The method also includes transmitting data indicating an unusable channel time value of the channel to one or more devices of the data link group. The unusable channel time value determined based on the first usage data and the second usage data.

In a particular aspect, a computer-readable storage device storing instructions that, when executed by a processor, cause the processor to perform operations including determining, at a first device of a data link group, first usage data of a channel of the data link group. The first usage data is associated with a time period. The operations further include identifying second usage data of the channel of a data link group. The second usage data is received at the first device from a second device of the data link group responsive to a query sent from the first device to the second device and is associated with the time period. The operations also include determining an unusable channel time value of the channel based on the first usage data and the second usage data.

In another particular aspect, an apparatus includes means for determining first usage data at a first device of a data link group. The first usage data corresponds to a channel of the data link group and is associated with a time period. The apparatus further includes identifying second usage data of the channel of a data link group. The second usage data received at the first device from a second device of the data link group responsive to a query sent from the first device to the second device and is associated with the time period. The apparatus also includes determining an unusable channel time value of the channel based on the first usage data and the second usage data.

### V. BRIEF DESCRIPTION OF THE DRAWINGS

FIG. 1 is a diagram of a particular implementation of a system that includes at least one device configured to determine an unusable channel time value of a channel of a data link group;

FIG. 2 is a flow diagram of a first illustrative method of operation at a device of a data link group;

FIG. 3 is a flow diagram of a second illustrative method of operation at a device of a data link group; and

FIG. 4 is a diagram of a wireless device that is operable to support various implementations of one or more methods, systems, apparatuses, and computer-readable media disclosed herein.

### VI. DETAILED DESCRIPTION

Particular implementations of the present disclosure are described below with reference to the drawings. In the description, common features are designated by common reference numbers throughout the drawings. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term).

As used herein, various terminology is for the purpose of describing particular implementations only and is not intended to be limiting of implementations. For example, the singular forms “a,” “an,” and “the” are intended to include the plural forms as well, unless the context clearly indicates otherwise. It may be further understood that the terms “comprises” and “comprising” may be used interchangeably with “includes” or “including.” Additionally, it will be understood that the term “wherein” may be used interchangeably with “where.”

In the present disclosure, devices in a data link group of a neighbor aware network (NAN) or a wireless mesh network may independently assess a channel condition (e.g., a channel quality) of a channel of the data link group. For example, each device of the data link group may determine its own channel utilization data. Channel utilization data may include statistical data regarding data reception, data transmission, or both, and each device may generate corresponding channel utilization data during or after data reception, data transmission, or both. The channel utilization data may include an amount of time the device received unicast data packets via the channel, an amount of time the device received broadcast data packets via the channel, or both. Additionally or alternatively, the channel utilization data may include an amount of time the device transmitted unicast data packets via the channel, an amount of time the device transmitted broadcast packets via the channel, or both.

In some implementations, a device may periodically determine its channel utilization data for a prior duration of time. As an illustrative, non-limiting example, a device of a data link group may, every second, determine its channel utilization data for the past five seconds. The device may communicate its channel utilization data to other devices. For example, the device may send its channel utilization data as a bitmap, where each bit of the bitmap corresponds to a different portion of the period of time. A value of a particular bit of the bitmap may indicate whether or not the device was communicating (e.g., sending or receiving) data during a corresponding portion of the period of time.

Each device can share its channel utilization data with other devices of the data link group. Additionally or alternatively, each device may broadcast its channel utilization data such that devices that are not included in the data link group may receive the channel utilization data. After a device of the data link group receives channel utilization data from each other device of the data link group, the device may compute a total channel unusability time of the channel of the data link group.

Unusable channel time may be a relatively reliable indicator of operating channel conditions, and may be computed as Unusable Channel Time=Total Channel Utilization−NDL Channel Time. Total Channel Utilization may be an amount of time the channel is sensed as busy by a device. NDL channel time may be determined by summing the channel utilization data for each device of the data link group. In some implementations, one or more devices of the data link group may calculate a channel unusabilty time of the channel of the data link group. In other implementations, each device of the data link group may calculate a channel unusabilty time of the channel of the data link group. If less than all devices of the data link group calculate a channel unusabilty time of the channel of the data link group, at least one of those devices may share its calculated channel unusabilty time with other devices of the data link group.

In response to a determination that a channel unusability time satisfies (e.g., is more unusable than) a first threshold, at least one device of the data link group may scan another channel. For example, another channel may be proactively scanned by the at least one device to gather sufficient samples to identify a channel to switch to in the event conditions on a current channel deteriorate (e.g., the channel unusability time increases) to the point that the current channel is no longer suitable for a particular service. To illustrate, in response to a determination that the channel unusability time satisfies (e.g., is more unusable than) a second threshold, one or more devices may quickly identify an alternate channel on which to move data link group operations. In some implementations, multiple devices may collaborate to identify the alternate channel based on scan reports of one or more channels that were proactively scanned.

In some implementations, at least one device of the data link group may operate as a scheduler device. A scheduler device may be configured to make decisions about when to scan channels and when to switch to an alternate channel. A scheduler device may be a provider device of the data link group, a device with a highest master rank of the data link group, a device having access to a reliable power source (e.g., plugged into an electrical outlet rather than operating on a battery), or a combination thereof, as illustrative, non-limiting examples. The scheduler device may query other devices of the data link group for channel utilization data, which may result in less channel congestion than in scenarios where each device of the data link group broadcasts its channel utilization data to the other devices of the data link group. The scheduler may determine the channel unusability time and may broadcast the channel utilization time to other devices. Additionally or alternatively, the scheduler device may instruct other devices to scan one or more channels and may request scan reports from the other devices. Based on the scan reports received by the scheduler device, the scheduler device may select an alternate channel for the data link group to switch to and may initiate a data link group channel change operation.

In some implementations, a device of the data link group may receive channel information, such as loading data or unusability time of a particular channel, from a particular device that is not included in the data link group. For example, the particular device may include an access point or a device included in a second data link group. Additionally or alternatively, a device of the data link group may determine an estimated channel utilization of a channel based on traffic advertisements received during a paging window of the data link group. The device may estimate an amount of data link traffic based on the traffic advertisement, a number of devices indicated to be transmitting data, a number of devices indicated to be receiving data, or a combination thereof. The device of the data link group may utilize the channel information, the estimated channel utilization, or both, when determining whether to scan a channel, whether to change channels, or a combination thereof, as illustrative, non-limiting examples.

In some implementations, devices of a data link group may determine whether to scan alternate channels, whether to initiate a channel change procedure, or both, based on a time-block size. For example, in response to a determination that a time-block size satisfies (e.g., is greater than or equal to) a third threshold, at least one device of the data link group may scan another channel. Additionally or alternatively, in response to a determination that a time-block size satisfies (e.g., is greater than or equal to) a fourth threshold, one or more devices may quickly identify an alternate channel on which to move data link group operations. Performing operations based on the time-block size may be used in addition to the channel unusability time. To illustrate, a device may determine to scan for alternate channels in response to the time-block size satisfying the third threshold, and may determine to initiate a channel change procedure in response to the channel unusability time satisfying the second threshold.

In some implementations, a device may be configured to offer a service to scan various channels and to provide channel information based on the results of such scanning. For example, the device may provide information, such as channel load, time spent scanning, a bitmap that indicates when the channel was busy during a time window, etc., for each channel that is scanned. The device that offers the service to scan the various channels may be a provider device of the data link group, a scheduler of the data link group, or another device of the data link group. In some implementations, the device may scan a particular channel identified in a request received from another device when the other device registers for the service.

By sharing channel utilization data, one or more devices of a data link group may independently determine a channel unusability time of a channel of the data link group. The channel unusability time may provide an indication of operating conditions of the channel and may enable a device to assess current channel conditions. Based on the channel unusability time, a device of the data link group may proactively scan other channels to find a better channel, may collaborate with other devices of the data link group to find an alternate channel on which to move data link group operations, or both. Proactively scanning other channels may enable the devices of the data link group to quickly find alternate channel(s). Switching to an alternate channel may reduce channel unusability time (as compared to the channel unusability time of the previous channel), thereby improving operating conditions of the data link group.

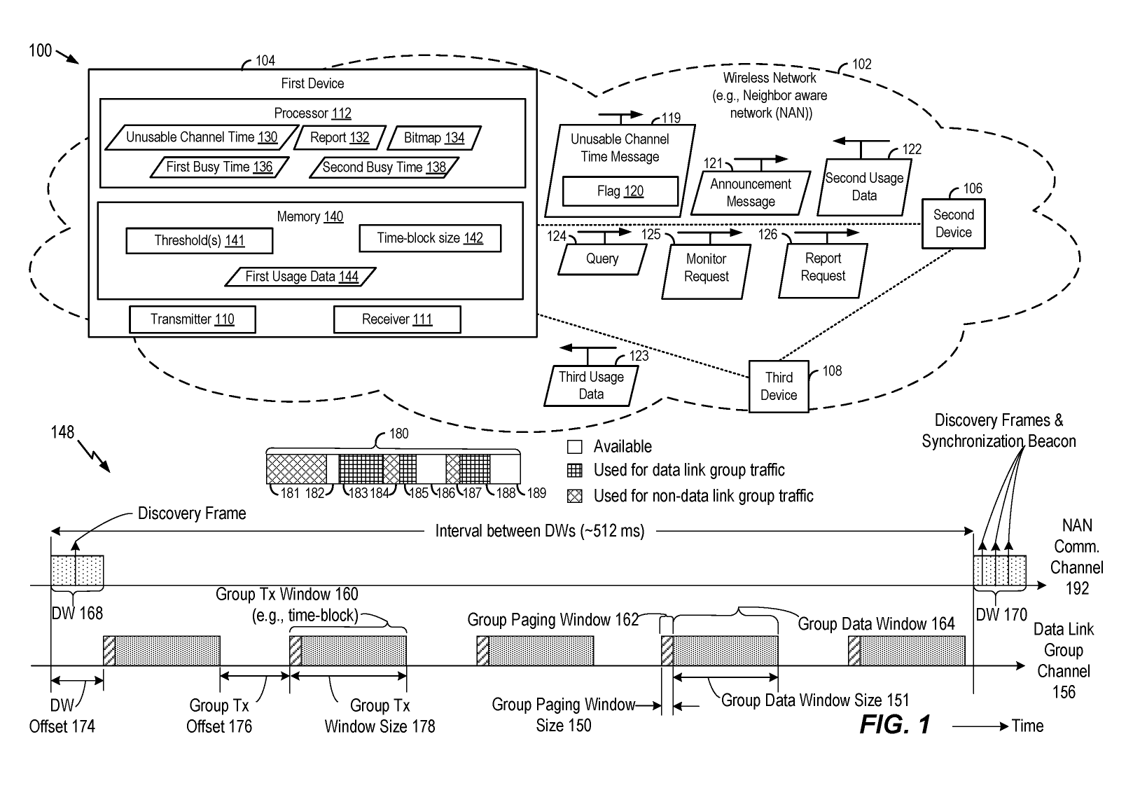

Referring to FIG. 1, a particular implementation of a system 100 that includes one or more devices of a data link group is shown. The system 100 includes a wireless network 102, such as a NAN or wireless mesh network, that supports independent assessment of a channel condition (e.g., a channel quality) of the data link group by devices of the data link group.

The wireless network 102 may include one or more devices, such as a first device 104, a second device 106, and a third device 108. Each of the devices 104-108 may be a wireless communication device configured to transmit data and to receive data from one or more other wireless communication devices included in the wireless network 102. Each wireless device may include or correspond to a station, such as a wireless station or a wireless communication device. The wireless network 102 may be an infrastructure network or an infrastructure-less network, such as a peer-to-peer (P2P) network (e.g., an ad-hoc network). For example, each of the devices 104-108 of the wireless network 102 (e.g., the NAN) may be configured to perform association operations (e.g., security association operations), security information exchange operations, synchronization operations, negotiation operations, and other operations via one or more wireless channels corresponding to the NAN. In some implementations, the devices 104-108 may perform such operations in accordance with one or more standards, such as an Institute of Electrical and Electronics Engineers (IEEE) 802.11 standard (e.g., a IEEE 802.11s standard), a Wi-Fi Alliance standard, a NAN standard, or a combination thereof, as illustrative, non-limiting examples. Although the wireless network 102 is illustrated as including three devices, in other implementations the wireless network 102 may include more than three devices or fewer than three devices.

The wireless network 102 may include or correspond to one or more data link groups. As used herein, a data link group may include an infrastructure-less peer-to-peer network, such as an ad-hoc network. The data link group may include multiple devices that are able to form a network, such as a decentralized wireless network. Additionally, each device of the data link group may use common security credentials that may be exchanged using a channel of the data link group or another channel, such as a channel of a NAN. In some implementations, the devices of the data link group may be synchronized to have periodic wake-up times, such as time periods when each of the devices is awake to advertise and receive traffic and other messages.

The wireless network 102 may include or correspond to a data link group that includes one or more devices, such as the devices 104-108. The data link group may also be referred to as a data link, a data link network, a group network, a NAN data link (NDL), a NDL network, a data path group, a data path group network, a NAN data path, a NAN data path group, or a NAN data path group network. In some implementations, the data link group may be a mesh group included in a mesh network, such as a “social Wi-Fi mesh network” or an Institute of Electrical and Electronics Engineers (IEEE) 802.11s mesh network, as illustrative, non-limiting examples. As another example, the data link group may include an infrastructure-less peer-to-peer network.

As part of the data link group, the devices 104-108 may perform data exchanges via wireless communications that do not involve one or more wireless carriers, one or more Wi-Fi access points, one or more GOs, the Internet, or a combination thereof. For example, the devices 104-108 of the data link group may share a security credential, such as a group key, to enable communication. To illustrate, each device of the data link group may use the group key to encode and decode group messages. In some implementations, one or more services, such as a music service, a social media sharing service, a file sharing service, a gaming service, a channel quality assessment service (e.g., a channel scanning service), or other services may be provided by one or more of the devices 104-108 of the data link group. In some implementations, the devices 104-108 of the data link group may be synchronized to have periodic wake-up times, such as time periods when each of the devices 104-108 is “awake” (e.g., in an active operating mode) to advertise a service, to receive traffic or other messages, or a combination thereof. In some implementations, the wireless network 102 may include multiple data link groups, and each data link group of the wireless network 102 may have a corresponding group identifier, such as a unique byte value, a group address, or a combination thereof. In implementations where the wireless network 102 includes multiple data link groups, a particular device may be included in more than one data link group. Although FIG. 1 illustrates a data link group having three devices, in other implementations more than three devices or fewer than three devices may be included in a data link group.

An illustrative example of a timing diagram of messages that may be communicated in the data link group is depicted at 148. The timing diagram 148 illustrates a NAN communication channel 192 and a data link group channel 156. The NAN communication channel 192 includes multiple discovery windows, such as a first discovery window (DW) 168 and a second discovery window 170. In some implementations, there may be a discovery window time interval of approximately 512 milliseconds (ms) between consecutive discovery windows. The data link group channel 156 includes multiple group transmission windows, such as a representative group transmission window 160. In some implementations, the group transmission windows occur with reference to the NAN communication channel 192. For example, when there is no data link group channel 156, the group transmission windows occur with reference to the NAN communication channel 192 and may be between the first discovery window 168 and the second discovery window 170.

In other implementations, the data link group channel 156 may include discovery windows (similar to the discovery windows 168, 170) and the group transmission windows occur between two discovery windows of the data link group channel 156. In some implementations, the discovery windows of the data link group channel 156 may be in addition to the first discovery window 168 and the second discovery window 170 of the NAN communication channel 192. In other implementations, there may be no NAN communication channel 192. In these implementations, the data link group channel 156 may have corresponding discovery windows.

In some implementations, the data link group may be included in a NAN and the devices of the data link group may communicate via the NAN communication channel 192. The devices of the NAN may be synchronized via one or more synchronization beacons that are communicated by a master device of the NAN or by a master device of a particular group of the NAN. For example, one of the devices of the data link group may operate as the master device and may broadcast one or more synchronization beacons to other devices included in the NAN via the NAN communication channel 192.

Additionally or alternatively, the devices included in the data link group may communicate via the data link group channel 156. The devices of the data link group may be synchronized via one or more synchronization beacons that are communicated by a master device of the data link group or a master device of a NAN that includes the data link group. For example, one of the devices of the data link group may operate as the master device and may broadcast one or more synchronization beacons to other devices of the data link group, other devices of the NAN, or a combination thereof, via the NAN communication channel 192, the data link group channel 156, or both.

Devices of a data link group may perform communication via the data link group channel 156 according to a transmission schedule. The transmission schedule may indicate a discovery window offset 174. The discovery window offset 174 may be a particular duration between an end of a discovery window (e.g., a first discovery window 168 of the wireless network 102) and a beginning of a subsequent group transmission window of the data link group channel 156. A group transmit (Tx) repeat value of the transmission schedule may indicate that multiple group transmission windows, such as the group Tx window 160, are repeated between consecutive discovery windows, such as the first discovery window 168 and the second discovery window 170.

A group Tx offset 176 of the transmission schedule may be a particular duration between consecutive group transmission windows. A group Tx window size 178 of the transmission schedule may correspond to a size (e.g., duration) of each group transmission window (e.g., each group Tx window 160). The group Tx window size 178 may also be referred to as a time-block size. Each group Tx window 160 may include a group paging window 162 and a group data window 164. A value of a group paging window size 150 of the transmission schedule may indicate a size (e.g., a duration) of the group paging window 162. A value of a group data window size 151 of the transmission schedule may indicate a size (e.g., a duration) of the group data window 164. In some implementations, the data link group may use multiple group channels and group Tx windows of the data link group may be divided among the multiple group channels. For example, a first time-block may occur at a first time on the data link group channel 156 between the discovery windows 168 and 170, and a second time-block may occur at a second time between the discovery windows 168 and 170 on a second group channel of the data link group after completion of the first time-block.

In some implementations, one or more frames (e.g., discovery frames) and/or synchronization beacons may be broadcast via the NAN communication channel 192 of the wireless network 102. For example, a device may send a discovery frame during one or more discovery windows. To illustrate, the first device 104 may broadcast the discovery frame during the first discovery window 168, the second discovery window 170, or both. The discovery frame may be received and used by a device that is not included in the wireless network 102 to “discover” the wireless network 102 (or the data link group network). Additionally, the discovery frame may enable the device to join the wireless network 102 (or the data link group network). A synchronization beacon may be used by multiple devices of the wireless network 102 for time synchronization function (TSF) correction. For example, the synchronization beacon may include a timestamp that is used to update timers, such as a TSF clock, of devices of the wireless network 102.

During a discovery window, such as the first discovery window 168, each of the devices of the data link group may be awake and may monitor one or more channels, such as the NAN communication channel 192, for beacons, messages, or both. In some implementations, the beacons, the messages, or both may indicate traffic to be sent during a subsequent data window. Beacons and/or messages sent during the discovery window may be secure (e.g., encoded or encrypted) or un-secure (e.g., un-encoded or unencrypted). A secure beacon or secure message transmitted during the discovery window may be encoded using a key, such as a group key of the data link group. If a particular device determines, based on beacon(s) or message(s) received during the discovery window, that the particular device will be receiving traffic data during the subsequent data window, the particular device may stay awake during the subsequent data window. Conversely, if a device does not receive such an indication, the device may “go to sleep” (e.g., enter a sleep mode or power-save mode) during the subsequent data window. Alternatively, if a device does not receive such an indication, the device may stay awake an perform an operation during the subsequent data window, such as monitoring traffic of a channel of the data link group or traffic of another channel.

During a paging window, each of the devices of the data link group may be awake and may monitor for beacons, messages, or both. In some implementations, the beacons, the messages, or both may indicate traffic to be sent during a subsequent data window. Beacons and/or messages sent during the paging window may be secure (e.g., encoded or encrypted) or un-secure (e.g., un-encoded or unencrypted). It is noted that, in some implementations, un-secure messages may be received and deciphered by a device regardless of whether or not the device is included in the data link group. When a secure beacon or a secure message is transmitted during the paging window, the secure beacon or the secure message may be encoded using a key, such as a group key (for data link group addressed traffic) or a pairwise key (for peer-to-peer addressed traffic). It is noted that data link group addressed traffic can be broadcast to each device of the data link group or can be unicast to a single device of the data link group. If a particular device determines, based on beacon(s) or message(s) received during the paging window, that the particular device may receive traffic data during the subsequent data window, the particular device may stay awake during the subsequent data window. Alternatively, if the particular device does not receive an indication that it may receive data, the particular device may “go to sleep” (e.g., enters the sleep mode or the power-save mode) during the subsequent data window.

As shown in FIG. 1, the first device 104 may include a processor 112, a memory 140, a transmitter 110, and a receiver 111. The transmitter 110 is configured to transmit data, such as messages represented by one or more data packets, to one or more devices. The receiver 111 may be configured to receive data from one or more devices. The memory 140 may be configured to store data, such as one or more thresholds 141 and a transmission schedule of the data link group. The transmission schedule may include one or more parameters, such as a time-block size (TB_{size}) 142. The time-block size (TB_{size}) may include or correspond to the group Tx window size 178.

The processor 112 may be configured to perform one or more operations corresponding to operation of the data link group. For example, the processor 112 may be configured to perform operations to determine (e.g., calculate) an unusable channel time of a channel (e.g., the data link group channel 156) as described further herein.

During operation, the first device 104 determine an unusable channel time 130 (e.g., an unusable channel time value) for a channel of the data link group. The unusable channel time 130 may be determined for a time period and may be a relatively reliable indicator of operating channel conditions of the channel. Unusability (e.g., unusable channel time 130) is time a channel is used by another device (e.g., devices of another network, such as another data link group network, an access point network, a mesh network, etc.). For example, Unusable Channel Time=Total Channel Utilization−Data Link Group Channel Time, where Total Channel Utilization is an amount of time the channel is sensed busy during the time period. To illustrate, FIG. 1 depicts a particular time period 180 associated with the data link group channel 156. The time period 180 illustrates portions (e.g., time intervals) of the time period 180 when the data link group channel 156 is available (e.g., no communications are detected via the data link group channel 156), is in use for data link group traffic, and is in use for non-data link group traffic. For example, the data link group channel 156 is available (for data link group traffic or non-data link group traffic) during time intervals 182, 186, and 189, is used for data link group traffic during time intervals 183, 185, and 188, and is used for non-data link group traffic during time intervals 181, 184, and 187. Accordingly, the Unusable Channel Time corresponds to an amount of time (i.e., a sum of durations of the time intervals 181, 184, and 187) of the time period 180 that the data link group channel 156 is not available for data link group traffic or utilized for data link group traffic. The first device 104 may calculate a first amount of time (e.g., a sum of durations of the time intervals 181, 183, 184, 185, 187 and 188 of the time period 180) corresponding to the Total Channel Utilization time. The first device 104 may subtract a second amount of time (e.g., a sum of durations of the time intervals 183, 185, and 188 of the time period 180) corresponding to the Data Link Group Channel Time from the first amount of time to calculate the Unusable Channel Time.

A channel may be sensed as busy due to a data link group addressed transmission or due to a non-data link group addressed transmission (i.e., a broadcast message or a message addressed to another data link group). The Data Link Group Channel Time is an amount of time the channel is busy due to traffic data link group addressed traffic (e.g., data link group broadcast messages, data link group unicast messages, or both). The first device 104 may determine the Data Link Group Channel Time as a sum of all data link group usage data (e.g., receive (Rx) times, transmit (Tx) times, or a combination thereof) determined by devices of the data link group during the time period.

To illustrate, to determine the unusable channel time 130, the first device may monitor the channel of the data link group to determine a first busy time 136 that corresponds to the Total Channel Utilization. The first device 104 may also determine a second busy time 138 that corresponds to the Data Link Group Channel Time. The first device 104 may determine the unusable channel time 130 (e.g., the unusable channel time value) based on a difference between the first busy time 136 and the second busy time 138.

To determine the second busy time 138, the first device 104 may sum usage data determined by each device of the data link group. For example, each device of the data link group may determine its own usage data for a channel with respect to a time period as an amount of time that device transmitted or received data on the channel during the time period. To illustrate, the first device 104 may determine first usage data 144, the second device 106 may determine second usage data 122, and the third device 108 may determine third usage data 123. The first device 104 may store the first usage data 144 in the memory 140. Each device of the data link group may send its usage data to the first device 104, and the first device 104 may sum the received usage data to determine the second busy time 138.

As an illustrative example, to enable the first device 104 to determine the Data Link Group Channel Time, each of the devices 104-108 of the data link group may compute a receive (Rx) air time (Rxₜᵢₘₑ) for every data packet corresponding to the data link group that is received by the device. For example, each device may compute the receive air time (Rxₜᵢₘₑ) for each unicast data link group packet received by the device. The receive air time (Rxₜᵢₘₑ) may be computed as:

Rxₜᵢₘₑ=Rx_{packet}_{_}_{size}*data_rate,

where Rx_{packet}_{_}_{size} is a size of a received data packet and data rate is a receive data rate. Each device may calculate its own total receive time for a time period. In some implementations, the time period may be a sliding window, such as a previous 5 second time period. A device of the data link group may broadcast its computed total receive time to other devices of the data link group. For example, the second device 106 may broadcast the second usage data 122, including an indication of the calculated total receive time of the second device 106 for the period of time. As another example, the third device 108 may broadcast the third usage data 123, including an indication of the calculated total receive time of the third device 108 for the period of time. Devices of the data link group may transmit their total receive time periodically, such as every 1 second. The broadcast can occur during a NAN discovery window, such as the first discovery window 168, or can be sent out during one of the data link group time-blocks, such as during the group Tx window 160. If an indication of the total receive time is transmitted during the NAN discovery window, then devices outside the data link group may receive the indication. Alternatively, if the indication is sent during a time-block, then the indication may be encoded using a key of the data link group and only devices of the data link group may be able to receive and decode the indication.

In this example, each device of the data link group that receives usage data (e.g., total receive times) from the other devices of the data link group may compute a Data Link Group Channel Time (NDL_{channel}_{ₜᵢₘₑ}) as a sum of: all the received unicast Rx times from other devices (i.e., each device's

$${Total}_{{Unicast}_{{Rx}_{time}}} ) ,$$

the device's own Rx time for unicast messages and broadcast messages (All_Rxₜᵢₘₑ_{_}ₐₜ_{_}_{device}), and the device's own Tx time for broadcast traffic (Bcast_Txₜᵢₘₑ_{_}ₐₜ_{_}_{device}). To illustrate:

$${NDL}_{{channel}_{ time}} = \sum {Total}_{{Unicast}_{{Rx}_{time}}} + {All\_Rx}_{ time \_ at \_ device} + {Bcast\_Tx}_{ time \_ at \_ device} .$$

For a time period, each device may independently compute the channel unusable channel time based on the Data Link Group Channel Time (NDL_{channel}_{_}ₜᵢₘₑ) of the time period calculated at the device and the Total Channel Utilization determined at the device for the time period.

As another illustrative example, to enable the first device 104 to determine the Data Link Group Channel Time, each of the devices 104-108 of the data link group may compute a transmit (Tx) air time (Txₜᵢₘₑ) for every data packet corresponding to the data link group that the device transmits. For example, each device may compute the transmit air time (Txₜᵢₘₑ) for each unicast and/or broadcast data link group packet transmitted by the device. The transmit air time (Txₜᵢₘₑ) may be computed as:

Txₜᵢₘₑ=Tx_{packet}_{_}_{size}*data_rate

where Tx_{packet}_{_}_{size} is a size of a received data packet and data_rate is a transmission data rate. Each device may calculate its own total transmit time for a time period. In some implementations, the time period may be a sliding window, such as a previous 5 second time period. A device of the data link group may broadcast its computed total transmit time to other devices of the data link group. For example, the second device 106 may broadcast the second usage data 122, including an indication of the calculated total transmit time of the second device 106 for the period of time. As another example, the third device 108 may broadcast the third usage data 123, including an indication of the calculated total transmit time of the third device 108 for the period of time. Devices of the data link group may transmit their total transmit time periodically, such as every 1 second. The broadcast can occur during a NAN discovery window, such as the first discovery window 168, or can be sent out during one of the data link group time-blocks, such as during the group Tx window 160. If an indication of the total transmit time is transmitted during the NAN discovery window, then devices outside the data link group may receive the indication. Alternatively, if the indication is sent during a time-block, then the indication may be encoded using a key of the data link group and only devices of the data link group may be able to receive and decode the indication.

In this example, each device of the data link group that receives usage data (e.g., total transmit times) from the other devices of the data link group may compute a Data Link Group Channel Time (NDL_{channel}_{_}ₜᵢₘₑ) as a sum of all the received Tx times from other devices (i.e., each device's Total_Txₜᵢₘₑ) and the device's own Tx time (Txₜᵢₘₑ_{_}ₐₜ_{_}_{device}). To illustrate:

NDL_{channel}_{_}ₜᵢₘₑ=ΣTotal_Txₜᵢₘₑ+Txₜᵢₘₑ_{_}ₐₜ_{_}_{device}

For a time period, each device independently compute the channel unusable channel time based on the Data Link Group Channel Time (NDL_{channel}_{_}ₜᵢₘₑ) of the time period calculated at the device and the Total Channel Utilization determined at the device for the time period.

In some implementations, a device may divide a time period into multiple sub-portions of the same or different duration. For example, a device may divide a time, such as 512 ms between consecutive discovery windows, into 4 ms portions. The device may represent the time period as a bitmap, where each bit corresponds to a different 4 ms portion. Accordingly, a discovery window interval may be represented with 512 ms/4 ms/8 bits=16 bytes. Each device that broadcasts its total transmit time may represent each discovery window interval as a 16 octet bitmap in which a bit is set to 1 if the device transmitted traffic to the data link group during a 4 ms portion that corresponds to that bit position. The bitmap may be used to identify if multiple devices of the data link group transmitted data during the same 4 ms portion, which may have resulted in a collision. For example, a device may align two bitmaps that correspond to the same time period and determine whether two devices were both transmitting during the same 4 ms portion. Identifying collisions may provide clues for identifying a reason why data link group performance is degraded (e.g., because there is too much overlapping traffic by devices of the data link group on the same channel). When a large number of collision indications are identified, a device may determine that changing channels may not correct an ongoing data link group QoS issue (i.e., unusable time on a data link group channel is not the issue).

In some examples, after determining the unusable channel time 130, the first device 104 may compare the unusable channel time 130 to one or more thresholds 141 stored in the memory 140. To illustrate, the first device 104 may determine that the channel conditions have deteriorated in response to the unusable channel time 130 satisfying the first threshold. In some implementations, the unusable channel time 130 may satisfy the first threshold when the unusable channel time 130 is greater than or equal to the first threshold. In other implementations, the unusable channel time 130 may satisfy the first threshold when the unusable channel time 130 is less than or equal to the first threshold.

In response to the unusable channel time 130 satisfying (e.g., being greater than or equal to) the first threshold, the first device 104 may initiate channel scanning at the first device 104, or may instruct another device of the data link group to initiate scanning. During scanning, a device may scan (e.g., monitor) one or more channels. For example, a scanning device may hop to a channel between time-blocks or during a portion of time-block in which the device has no activity (i.e., no more incoming or outgoing traffic) and assess channel load conditions. The scanning device may randomly select the order of channels to scan or may scan a shorter ‘candidate’ channel list of available channels to scan. In some implementations, a device may store a history of previous scans (e.g., for a certain period of time) and may select the channel scan order based on which channels were previously determined to be busy or not busy. For example, if 2 out of 5 channels were previously determined to be busy, a device may order the 5 channels to be scanned such that the 2 previously busy channels are scanned last. If a validity period of the previous scan has expired, then a record of the previous scan may be purged or not considered when determining scan order. In some cases, a device may process received packets on a particular channel to determine the type of data traffic (e.g., short-lived traffic, such as an announcement message, or long-term traffic, such as traffic of a streaming service) to estimate a life-time of a link that uses the particular channel. This may be useful to make decisions on whether or not to avoid a particular channel during the next scan. For example, if the traffic type indicates a short lived service on a particular channel, the device may choose to scan the particular channel before other channels.

In some implementations, the first device 104 may begin scanning based on the unusable channel time 130 determined by the first device 104. Additionally or alternatively, the first device 104 may send an unusable channel time message 119 to one or more other devices. The unusable channel time message 119 may include an indication of the unusable channel time 130. The unusable channel time message 119 may optionally include a flag 120, where a value of the flag 120 indicates whether the unusable channel time 130 satisfied the first threshold (e.g., whether a device that receives the unusable channel time message 119 is to begin scanning). In some implementations, if the unusable channel time 130 satisfies the first threshold, the first device 104 may send a monitor request 125 to another device to instruct the other device to begin scanning. The monitor request 125 may indicate one or more channels to be scanned, a duration to scan at least one channel of the one or more channels, or a combination thereof. The unusable channel time message 119 may be transmitted as a broadcast message or as a unicast message. Additionally or alternatively, the unusable channel time message 119 may be transmitted during a NAN discovery window or during a data link group time-block.

In some implementations, after scanning one or more channels, a device may generate a scan report. To illustrate, the first device 104 may generate a report 132. The report 132 may include load condition data and a scan time value for a particular scanned channel. The first device 104 may broadcast the report 132 to other devices. For example, the first device may announce the report 132 by including the report 132 in an advertisement message, such as an announcement message 121. The announcement message 121 may be broadcast during a NAN discovery window or during a data link group time-block.

Additionally or alternatively, a device may request a scan report (e.g., a proactive scan report) from another device. For example, the first device 104 may send a report request 126 to the second device 106 for a scan report generated by the second device 106. To illustrate, the second device 106 may have scanned one or more channels and may have generated a corresponding scan report responsive to an unusable channel time calculated by the second device 106, responsive to the unusable channel time message 119, or responsive to the monitor request 125. The second device 106 may send the generated scan report to the first device 104 (e.g., via broadcast or unicast) in response to the report request 126. Additionally or alternatively, the second device 106 may send the scan report to the first device 104 without receiving the report request 126 (e.g., a scan report request).

In some implementations, the first device 104 that performs a channel scan may divide a period of time (e.g., 5 sec or 10 discovery window intervals) in to smaller chunks, such as portions of 16 ms each, as an illustrative, non-limiting example. The first device 104 may generate the report 132 as a bitmap, such as the bitmap 134, where each chunk is represented by a bit in the bitmap 134. The first device 104 may generate the bitmap 134 for a particular scanned channel such that a bit is asserted (or de-asserted) for the channel if the first device 104 scanned the channel during a corresponding chunk of time. Such a bitmap may be useful in reaffirming a scan sample (e.g., multiple devices found this channel to have no traffic during this time) or to identify insufficient samples. Such a bitmap may also be useful in computing a new or revised time-block schedule (e.g., a transmission schedule) for the data link group.

In some implementations, after determining the unusable channel time 130, the first device 104 may compare the unusable channel time 130 to a second threshold to determine whether to initiate a channel change operation. To illustrate, the first device 104 may determine that the channel conditions have deteriorated in response to the unusable channel time 130 satisfying (e.g., being greater than or equal to) the second threshold. The second threshold may have a greater value as compared to the first threshold. In some implementations, the unusable channel time 130 may satisfy the second threshold when the unusable channel time 130 is greater than or equal to the second threshold. In other implementations, the unusable channel time 130 may satisfy the second threshold when the unusable channel time 130 is less than or equal to the second threshold.

In response to the unusable channel time 130 satisfying (e.g., being greater than or equal to) the second threshold, the first device 104 may initiate a channel change operation that causes devices of the data link group to switch from a using a channel to using a new channel. To determine which channel to switch to, the first device 104 may review the proactive scan report(s) and decide if more samples are needed. The first device may have received the proactive scan report(s) by querying other devices or by listening to active advertisements from other devices. If sufficient samples are present, the first device 104 may select the new channel to move data link group operations to. If there was no proactive scanning or if the samples from proactive scan(s) are insufficient, the first device 104 may request one or more devices to perform additional scanning of certain channels. Such a request (e.g., the monitor request 125) may include the amount of time to be spent scanning each of the channels. The request may be transmitted during a NAN discovery window or during a data link group time-block. In some implementations, when the request (e.g., the monitor request 125) is sent during a data link group time-block, a device that receives the request may use a remainder of the data link group time-block to perform a scan. To illustrate, the first device 104 may send the monitor request 125 during a paging window and one or more devices may perform a scan during a corresponding group data window. In some implementations, the first device 104 may include a bitmap, where each bit corresponds to a 16 ms chunk of time. The bitmap may correspond to a channel to be scanned and may indicate during which time period(s) the channel is to be scanned, based on which bits of the bitmap are asserted (or de-asserted).

The first device 104 may communicate an indication of the channel change operation to other devices of the data link group by transmitting a channel change announcement message, such as the announcement message 121. The channel change announcement message may be transmitted during a discovery window or during a data link group time-block. The channel change announcement message may include channel load conditions of the new channel and an amount of time the new channel was scanned. The load conditions and the scan time can act as a tie-breaker if multiple devices announce a channel change. For example, when different devices announce different channels for a channel change, the channel that was scanned for a longer period of time may be selected. Additionally or alternatively, the channel that has lower loading may be selected.

In some implementations, a device, such as the first device 104, may receive channel use information from a device that is not included in the same data link group as the first device 104. The channel use information may include load condition data corresponding to the channel (e.g., the data link group channel 156), information regarding channel usage by another data link group, etc. The device that is not included in the same data link group may include a mobile communication device, an access point, a base station, etc., as illustrative, non-limiting examples. The first device 104 may be able to utilize the channel use information to validate a determined unusable channel time value. In other implementations, the channel use information may be related to another channel and the first device 104 may decide to switch data link group operations to the other channel based on the channel use information.

In some implementations, the TB_{size} (e.g., the group Tx window size 178) may be used for assessing channel conditions. If a current TB_{size} is insufficient to support group addressed traffic, one or more data link group devices may determine to increase the TB_{size}. When TB_{size} satisfies (e.g., is greater than or equal to) a third threshold, the first device 104 may initiate proactive scanning by the first device 104 or by another device of the data link group. When TB_{size} satisfies (e.g., is greater than or equal to) a fourth threshold, the first device may initiate a channel change procedure. The value of the fourth threshold may be greater than a value of the third threshold.

In some implementations, a device (e.g., the first device 104) may estimate data link group channel utilization based on conditions (e.g., how many devices are transmitting data traffic or receiving data traffic) during time-block. For example, during a paging window, such as the group paging window 162, all devices participating in the data link group are expected to be awake to receive traffic (e.g., a traffic advertisement message) via the channel, such as the data link group channel 156. Traffic advertisements are broadcast via the channel and contain a traffic indication map (TIM) to indicate recipients of data to be transmitted during a group data window, such as the group data window 164, that corresponds to the paging window. Each data link group device that receives a traffic advertisement may process the traffic advertisement (e.g., the TIM) to determine whether or not the device is indicated as a recipient in the traffic advertisement.

In some implementations, the first device 104 can estimate the amount of traffic in the data link group based on one or more traffic advertisements received during a paging window. For example, the first device 104 may determine a number of paging devices and may identify each recipient device. Based on the number of paging devices and the identified recipient devices, the first device 104 can estimate the number of active links in the data link group. If several transmitter devices are indicating traffic (for many receiver devices), data link group channel utilization may be high and moving to another channel may not necessarily help (e.g., alleviate) unusable channel time (e.g., deteriorated channel conditions are due to collisions resulting from the high volume of traffic on the channel). Alternatively, if very few transmitter devices are indicating traffic (for few receiver devices) and a large time-block size is insufficient (i.e., transmitter devices are unable to send an end-of-service-period (EOSP) bit), the channel may be highly occupied leaving little room for data link traffic, and switching to another channel may be beneficial.

In some implementations, one or more devices of a NAN may offer a service to scan various channels for a switching operation. The one or more devices may provide information based on a scan. The information may be transmitted in a beacon and may include a channel load, time spent scanning a particular channel, a scan time bitmap that provides an indication of portions of a time period during which the particular channel was scanned, etc., as illustrative, non-limiting examples. Such information may also include details on whether or not the particular channel can meet QoS requirements of a particular service provided by a data link group. A device, such as the first device 104, that receives the information may cache the information if the scan of the particular channel was recently performed. A device that provides the channel scan service may also be a provider device of another service of a data link group. For example, the first device 104 may be a provider device of the data link group and may also provide a channel scan service. In some implementations, a device that transitions into a NAN master role also becomes a channel scanning device (i.e., a NAN master device is expected to scan channels and to provide channel information).

Operations described herein may be performed by one or more devices of a NAN or a data link group. For example, each device of a data link group may be configured to perform the operations described herein. As another example, a single device (or a sub-set of devices) of the data link group may be considered as the “owner” (e.g. a scheduler device) of the data link group and make scheduling decisions. The scheduler device may include (or establish) security parameters for the data link group, channel QoS parameters for the data link group, etc.

A device of a data link group may be designated as the scheduler device if the device is a provider device of the data link group. For example, a single provider device or multiple provider devices may each be designated as a scheduler device. If multiple devices are each designated as scheduler devices, arbitration may be used to identify when a particular scheduler device directs operations of other devices of the data link group. For example, the performance data of different scheduler devices can be compared to figure out which scheduler device is in a degraded quality of service situation. The scheduler device having the lowest quality of service may have authority to direct other devices of the data link group to scan one or more channels or to perform a channel change operation. Additionally or alternatively, a device may be designated as a scheduler device based on a master rank (a device with the highest master rank is designated as a scheduler device) or based on whether a device has access to (or is using) a reliable power source (e.g., plugged into an electrical outlet rather than operating on a battery). In some implementations, a device that is designated as a scheduler device may advertise that it is a scheduler device to other devices of the NAN.

In some implementations, the first device 104 may be a scheduler device. As the scheduler device, the first device 104 may send a query 124 to one or more devices of the data link group. The query 124 may request usage data from the one or more devices. The first device 104 may transmit the query 124 as a unicast message or as a broadcast message. Additionally or alternatively, the query 124 may be transmitted during a NAN discovery window or during a data link group time-block. Responsive to the query 124, the first device 104 may receive usage data from the one or more devices. For example, responsive to the query 124 that is broadcasted to the second device 106 and to the third device 108, the first device 104 may receive the second usage data 122 from the second device 106 and the third usage data 123 from the third device 108.

As the scheduler device, the first device 104 may compute the unusable channel time 130 as described above. After computing the unusable channel time 130, the first device 104 may transmit the unusable channel time 130 to one or more devices. For example, the first device 104 may transmit an indication of the unusable channel time 130 as the unusable channel time message 119. The first device 104 may transmit the unusable channel time message 119 as a unicast message or as a broadcast message. Additionally or alternatively, the unusable channel time message 119 may be transmitted during a NAN discovery window or during a data link group time-block. In some implementations, the unusable channel time message 119 may be transmitted a device regardless of whether or not the device is included in the data link group. To illustrate, the unusable channel time message 119 may be un-secure, so devices that are not part of the data link group can receive and decode the unusable channel time message 119.

In some implementations, the first device 104 configured to operate as the scheduler device may send the monitor request 125 to one or more devices to request the one or more devices to scan channels. The first device 104 may transmit the monitor request 125 as a unicast message or as a broadcast message. Additionally or alternatively, the monitor request 125 may be transmitted during a NAN discovery window or during a data link group time-block.

In some implementations, the first device 104 configured to operate as the scheduler device may send the report request 126 to one or more devices to request the one or more devices to provide a scan report to the first device 104. The first device 104 may transmit the report request 126 as a unicast message or as a broadcast message. Additionally or alternatively, the report request 126 may be transmitted during a NAN discovery window or during a data link group time-block. In some implementations, the first device 104 may receive a scan report from a device that is not included in the data link group. Based on information included in received scan report, in the report 132 generated by the first device 104, or both, the first device 104 may identify a channel to switch data link group operations to.

Although certain operations and functions of the system 100 have been described with respect to a corresponding device, each of the devices 104-108 may be configured to perform one or more operations, functions, or a combination thereof, described with reference to another of the devices 104-108. For example, each of the devices 104-108 may include corresponding process, a corresponding memory, a corresponding receiver, and a corresponding transmitter, as described with reference to the processor 112, the memory 140, the receiver 111, and the transmitter 110.

One advantage provided by at least one of the disclosed aspects is that one or more devices of a data link group may independently determine a channel unusability time of a channel of the data link group by sharing channel utilization data. The channel unusability time may provide a relatively reliable indicator of operating conditions of the channel and may enable a device to assess current channel conditions. Based on the channel unusability time, a device of the data link group may proactively scan other channels to find a better channel, may collaborate with other devices of the data link group to find an alternate channel on which to move data link group operations, or both. Proactively scanning other channels may enable the devices of the data link group to quickly find alternate channel(s). Switching to an alternate channel may reduce channel unusability time (as compared to the channel unusability time of the previous channel), thereby improving operating conditions of the data link group.

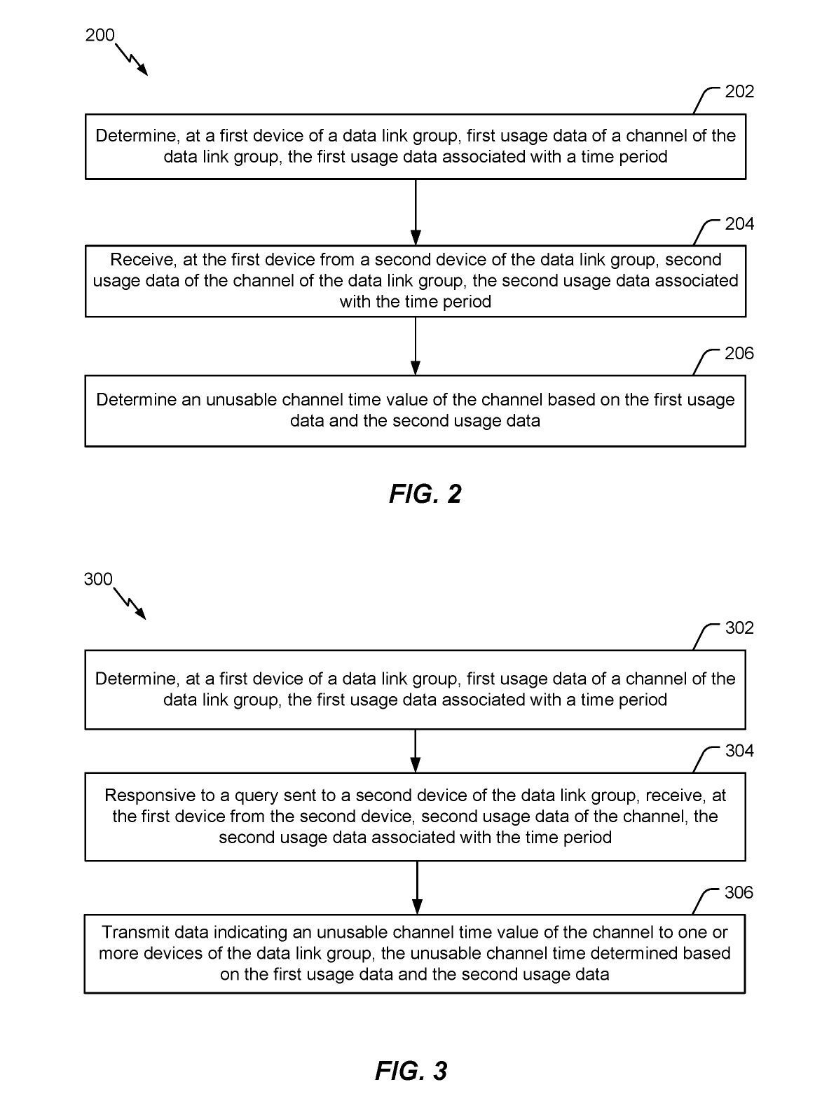

Referring to FIG. 2, a first implementation of a method 200 of operation at a device of a data link group is shown. For example, the method 200 may be related to a method of wireless communication at the device. The method 200 may be performed at any of the devices 104-108 of FIG. 1.

The method 200 includes determining, at a first device of a data link group, first usage data of a channel of the data link group, at 202. The first usage data may be associated with a time period. For example, the first device may include or correspond to the first device 104 of FIG. 1. The first usage data may include or correspond to the first usage data 144. The channel may include or correspond to the data link group channel 156 and the time period may include or correspond to the time period 180. In some implementations, the time period corresponds to a time period between two discovery windows of a NAN communication channel, such as the discovery windows 168 and 170 of the NAN communication channel 192.

The method 200 includes receiving, at the first device from a second device of the data link group, second usage data of the channel of a data link group, at 204. The second usage data may be associated with the time period. For example, the second device and the second usage data may include or correspond to the second device 106 and the second usage data 122, respectively.

The method 200 includes determining an unusable channel time value of the channel based on the first usage data and the second usage data, at 206. The unusable channel time value may include or correspond to the unusable channel time 130 of FIG. 1.

In some implementations, the second usage data may correspond to an amount of data link group traffic of the data link group received via the channel by the second device during a time period. In such implementations, determining the first usage data may include determining an amount of traffic received via the channel by the first device during the time period and determining an amount of traffic broadcasted via the channel by the first device during the time period.

In other implementations, the second usage data may correspond to an amount of data link group traffic of the data link group transmitted by the second device via the channel during a time period. In such implementations, determining the first usage data may include determining an amount of traffic transmitted by the first device via the channel during the time period.

In some implementations, the method 200 includes transmitting the first usage data to at least one device of the data link group. For example, the first device 104 may transmit the first usage data 144 via the transmitter 110. In illustrative examples, the first usage data may be transmitted to the at least one device via a unicast message or a broadcast message. In some examples, the first usage data may be transmitted to the at least one device during a discover window, such as the first discovery window 168, or during a time-block, such as the group Tx window 160, corresponding to the data link group.

In some implementations the method 200 includes, for each portion of a time period that includes multiple portions, determining whether the first device transmitted data link group traffic corresponding to the data link group via the channel during the portion. The method 200 may further include generating a bitmap including multiple bits, where each bit of the bitmap corresponds to a different portion of the multiple portions of the time period. The bitmap may include or correspond to the bitmap 134 of FIG. 1. A value of each bit may indicate whether the first device transmitted data during a corresponding portion of the time period. The method 200 may further include transmitting the bitmap to at least one device of the data link group. The method 200 may further include receiving a second bitmap from the second device, where each bit of the second bitmap corresponds to a different portion of the multiple portions of the time period. The method 200 may further include comparing a first bit of the bitmap to a first bit of the second bitmap to determine whether the first device and the second device both performed data transmission of data link group addressed traffic during a particular portion of the time period.

In some implementations, the method 200 includes monitoring, by the first device, the channel to determine a first amount of time that the channel is used for data link group traffic corresponding to the data link group and used for non-data link group traffic during a time period. The method 200 may further include determining a second amount of time the channel is used for the data link group traffic during the time period. The second amount of time may be determined based on a sum of the first usage data and the second usage data. The method 200 may further include determining the unusable channel time value based on a difference between the first amount of time and the second amount of time. The method 200 may further include receiving, at the first device, usage data of the channel from each device of the data link group, where the second amount of time is determined based on the usage data received from each device of the data link group. For example, the first device 104 may receive the second usage data 122 from the second device 106 and may receive the third usage data 123 from the third device 108. The first amount of time may include or correspond to the Total Channel Utilization (e.g., a total time the channel was in use by the data link group or otherwise busy, such as in use with non-data link traffic) and the second amount of time may include or correspond to the NDL Channel Time.

The method 200 may include monitoring (e.g., scanning) one or more channels. In a particular implementation, the method 200 further includes, prior to monitoring the one or more channels, receiving a request from a third device to monitor the one or more channels. The request may include or correspond to the monitor request 125 of FIG. 1. The request may indicate the one or more channels. In a second implementation, the method 200 further includes comparing the unusable channel time value to a first threshold. The one or more channels may be monitored in response to a determination that the unusable channel time value satisfies (e.g., is greater than or equal to) the first threshold.

In a third implementation, the method 200 further includes, after monitoring a second channel of the one or more channels, generating a report that includes load data corresponding to the second channel, an indication of how long the second channel was monitored, or a combination thereof. The report may include or correspond to the report 132 of FIG. 1. The method 200 may also include transmitting the report to another device of the data link group during a time-block of the data link group or during a discovery window. In a first example, the method 200 may further include receiving a request for the report from another device of the data link group, where the report is transmitted as a broadcast message or as a unicast message in response to receiving the request. The request may correspond to the report request 126 of FIG. 1. In a second example, the one or more channels may be monitored during a time period including multiple portions, and the method 200 may further include, for each channel of the one or more channels that is monitored, generating a bitmap including multiple bits. Each bit of the bitmap may correspond to a different portion of the multiple portions of the time period, and a value of each bit may indicate whether a particular channel was monitored during a corresponding portion of the time period. At least one bitmap may be included in the report.

In a fourth implementation, the one or more channels to be monitored may include a second channel and a third channel, and the method 200 may further include determining an order in which to monitor the second channel and the third channel. In a fifth implementation, the method 200 may further include receiving an announcement message from an access point. The announcement message may include load data corresponding to a second channel of the one or more channels. In some implementations, the method 200 may include determining whether to switch the data link group from the channel to the second channel based on the load data.

In a sixth implementation, the method 200 may further include, after determining the unusable channel time value, determining a second unusable channel time value of the channel. The method 200 may further include comparing the second unusable channel time value to a second threshold. The method 200 may further include, in response to a determination that the second unusable channel time value satisfies (e.g., crosses) the second threshold, generating a channel change announcement message. The channel change announcement message may correspond to the announcement message 121 of FIG. 1. The method 200 may further include transmitting the channel change announcement message to at least one device of the data link group.

In a seventh implementation, the method 200 may further include determining a size of a time-block of the data link group. The method 200 may further include comparing the size to a third threshold. The method 200 may include, in response to a determination that the size satisfies the third threshold, monitoring one or more channels. In some implementations, the size may satisfy the third threshold when the size is greater than or equal to the third threshold. In other implementations, the size may satisfy the third threshold when the size is less than or equal to the third threshold. The method 200 may include determining a second size of a second time-block of the data link group. The method 200 may further include comparing the second size to a fourth threshold. The method 200 may further include, in response to a determination that the second size satisfies the fourth threshold, generating a channel change announcement message. In some implementations, the second size may satisfy the fourth threshold when the second size is greater than or equal to the fourth threshold. In other implementations, the second size may satisfy the fourth threshold when the second size is less than or equal to the fourth threshold. The method 200 may include transmitting the channel change announcement message to at least one device of the data link group.

The method 200 of FIG. 2 enables one or more devices of a data link group to independently determine a channel unusability time of a channel of the data link group by sharing channel utilization data. The channel unusability time may provide an indication of operating conditions of the channel and may enable a device to assess current channel conditions. Based on the channel unusability time, a device of the data link group may proactively scan other channels to find a better channel, may collaborate with other devices of the data link group to find an alternate channel on which to move data link group operations, or both. Proactively scanning other channels may enable the devices of the data link group to quickly find alternate channel(s). Switching to an alternate channel may reduce channel unusability time (as compared to the channel unusability time of the previous channel), thereby improving operating conditions of the data link group.

Referring to FIG. 3, a second implementation of a method 300 of operation at a device of a data link group is shown. For example, the method 200 may be related to a method of wireless communication at the device. The method 300 may be performed at any of the devices 104-108 of FIG. 1.

The method 300 includes determining, at a first device of a data link group, first usage data of a channel of the data link group, at 302. The first usage data may be associated with a time period. For example, the first device may include or correspond to the first device 104 of FIG. 1. The first usage data may include or correspond to the first usage data 144. The channel may include or correspond to the data link group channel 156 and the time period may include or correspond to the time period 180.

The method 300 includes, responsive to a query sent to a second device of the data link group, receiving, at the first device from the second device, second usage data of the channel, at 304. The second usage data may be associated with the time period. For example, the second device and the second usage data may include or correspond to the second device 106 and the second usage data 122, respectively. The query may include or correspond to the query 124 of FIG. 1. In some implementations, the method 300 may optionally include querying each device of the data link group for usage data.

The method 300 includes transmitting data indicating an unusable channel time of the channel to one or more devices of the data link group, the unusable channel time value determined based on the first usage data and the second usage data, at 306. The unusable channel time value may include or correspond to the unusable channel time 130 of FIG. 1. The data indicating the unusable channel time may be transmitted by a transmitter of the first device, such as the transmitter 110 of FIG. 1. In some implementations of the method 300, the data may be transmitted as a unicast message or as a broadcast message. In some implementations of the method 300, the data may be transmitted during a discovery window of a neighbor aware network that includes the data link group, during a paging window portion of a time-block of the data link group, or during a transmission widow portion of the time-block of the data link group.

In some implementations, the method 300 may further include sending the query to the second device as a unicast message or as a broadcast message. The method 300 may further include sending the query to the second device during a discovery window of a neighbor aware network that includes the data link group, during a paging window portion of a time-block of the data link group, or during a transmission widow portion of the time-block of the data link group.

In some implementations of the method 300, the first device includes a scheduler device of the data link group. For example, the first device may include a provider device of the data link group. The provider device may be configured to monitor a particular channel and to provide report data corresponding to the particular channel to another device as service. The report data may include or correspond to the report 132 of FIG. 1.

In some implementations, the method 300 further includes designating the first device as a scheduler device of the data link group based on a rank of the first device within the data link group, whether the first device comprises a plugged-in device, or both. The method 300 may include, prior to designating the first device as the scheduler device, negotiating with one or more devices of the data link group to identify a particular device to operate as the scheduler device. The method 300 may include, after designating the first device as the at least one scheduler device, transmitting advertising data indicating that the first device is designated as a scheduler device via a communication channel of a neighbor aware network that includes the data link group. In some implementations, one or more devices of the data link group may generate and transmit (e.g., broadcast or unicast) advertising data via the communication channel of the neighbor aware network. The advertising data may indicate which device(s) of the data link group is designated as a scheduler device.

The method 300 may include receiving a first scheduler announcement transmitted from a particular scheduler device. For example, the particular scheduler device may periodically transmit scheduler announcement messages to inform devices of the data link group that the particular scheduler device is designated as a scheduler. The method 300 may further include, after receiving the first scheduler announcement, identifying expiration of a time period during which the first device failed to receive a second scheduler announcement. By failing to receive another scheduler announcement message during the time period, the first device may determine that the first scheduler device is no longer designated as a scheduler device of the data link group and that a new device may be designated as a scheduler. The method 300 may further include communicating one or more negotiation messages with one or more devices of the data link group to identify another device to operate as the scheduler device.

In some implementations, the method 300 may include identifying expiration of a time period during which the first device failed to receive a scheduler announcement. For example, the time period may correspond to an amount of time between discovery windows of a NAN. After expiration of the time period, the method 300 may include selecting the first device to be a scheduler device of the data link group and transmitting a second scheduler announcement. The second scheduler announcement may include data that indicates that the first device is the scheduler device (of the data link group). The first device may be selected (or may determine) to be the scheduler device based on a quality of the channel of the data link group, an amount of time the first device has been included in the data link group, a number of devices that joined into the data link group via the first device, or a combination thereof. For example, the first device may determine to be the scheduler device responsive to a determination that a quality of the channel (e.g., a channel unusable time, a signal-to-noise (SNR), etc.) satisfies a threshold. As another example, the first device may determine to be the scheduler device responsive to a determination that the number of devices that joined via the first device satisfies (e.g., is greater than or equal to) a threshold number.

In some implementations, regardless of whether the first device is the scheduler device, the first device may determine to initiate a channel change operation responsive to a determination that a quality of the channel (e.g., channel unusable time, signal-to-noise (SNR), etc.) satisfies a threshold and based on identification of a second channel having better quality conditions. To illustrate, the method 300 may include determining to switch the data link group from communicating via the channel to communicating via a second channel. The first device may transmit an announcement message to one or more devices of the data link group. The announcement message may include data instructing the one or more devices to switch from the channel to the second channel. The first device may be authorized (whether operating as the scheduler device or as a non-scheduler device) to initiate the channel change operation based on a neighbor aware network (NAN) rank, a media access control (MAC) address, being first (e.g., an initial device) in the data link group to announce a time synchronization function (TSF) schedule, a number of devices enrolled in the data link group by the first device, a data link group rank, a number of active links, an amount of time the first device has been included in the data link group, a quality of the channel, or a combination thereof.

In some implementations, the method 300 may further include determining a size of a time-block of the data link group. The size of the time-block may include or correspond to the time-block size 142 of FIG. 1. The method 300 may further include comparing the size to a threshold. The method 300 may further include, in response to a determination that the size satisfies (e.g., crosses) the threshold, monitoring one or more channels. The method 300 may further include determining a second size of a second time-block of the data link group. The method 300 may further include comparing the second size to a second threshold. The method 300 may further include, in response to a determination that the second size satisfies (e.g., crosses) the second threshold, generating a channel change announcement message. The method 300 may further include transmitting the channel change announcement message to at least one device of the data link group. The channel change announcement message may include or correspond to the announcement message 121 of FIG. 1.

In some implementations, the method 300 may include storing the second usage data at a location of a memory of the first device. The memory may include or correspond to the memory 140 of FIG. 1. The method 300 may further include, after receiving the second usage data, receiving, at the first device from the second device, third usage data of the channel responsive to a second query sent to the second device of the data link group. The method 300 may further include storing the third usage data at a second location of the memory. The method 300 may further include determining a second unusable channel time based on the third usage data.

In some implementations, the method 300 may include, after receiving the second usage data and responsive to a second query sent to the second device of the data link group, receiving, at the first device from the second device, third usage data of the channel. The second usage data may correspond to a first time period, and the third usage data may correspond to a second time period that is subsequent to the first time period. The method 300 may further include determining a second unusable channel time based on the first usage data, the second usage data, and the third usage data.

In some implementations, the method 300 further includes receiving one or more traffic indication messages during a paging window of a time-block of the data link group. The method 300 may further include estimating a channel utilization of the channel based on a number of traffic indication messages received during the paging window, a number of different transmitter devices that transmitted the one or more traffic indication messages, a number of receiver devices indicated by the one or more traffic indication messages, a number of devices included in the data link group, or a combination thereof. The method 300 may further include changing a size of one or more time-blocks of the data link group based on the estimated channel utilization. In some implementations, the channel utilization may be determined based on one or more parameters (e.g., requirements, such as a SNR threshold, a channel unusable time threshold, etc.) of an application (or service) of the data link group, a number of active communication links in the data link group, or both. The number of active communication links in the data link group may be determined as an average number of active links in the data link group during a time period, such as a time period between two discovery windows of a NAN. In other implementations, the time period corresponds to a portion of the time period between the two discovery windows, such as a time period corresponding to one or more transmission windows or one or more data windows. The number of active communication links may be determined by monitoring traffic announcement messages during a paging window of the data link group and identifying which devices of the data link group are indicated to transmit data and which devices of the data link group are indicated to receive data.

In some implementations, the method 300 may include comparing the unusable channel time value to a third threshold. The method 300 may further include monitoring one or more channels in response to a determination that the unusable channel time value satisfies the third threshold. Additionally or alternatively, the method 300 may include transmitting a request to the second device in response to a determination that the unusable channel time value satisfies the third threshold. In some implementations, the request instructs the second device to monitor one or more channels. For example, in some implementations, the request specifies the one or more channels to be monitored by the second device, an amount of time to monitor a particular channel of the one or more channels, or a combination thereof. The request may include or correspond to the monitor request 125 of FIG. 1.

In some implementations, the method 300 includes transmitting a report request from a third device of the data link group. The report request may include or correspond to the report request 126 of FIG. 1. The method 300 may further include, responsive to the report request, receiving the report from the third device. The report may include load data corresponding to a second channel, an indication of how long the second channel was monitored, or a combination thereof. In some implementations of the method 300, the report request may be transmitted in a broadcast message or a unicast message. In some implementations of the method 300, the report request may be transmitted during a discovery window of neighbor aware network (NAN), during a paging window portion of a time-block of the data link group, or during a transmission widow portion of the time-block of the data link group. The third device may be included in a second data link group. In some implementations of the method 300, receiving the report may include receiving a broadcast message or a unicast message that includes the report. In some implementations, the method 300 may further include determining, based on the report, whether to switch the data link group from the channel to the second channel or whether to request additional monitoring of the second channel.

In some implementations, the method 300 further includes announcing channel change from the channel to a second channel for the data link group. The announcement may include data indicating load conditions of the second channel, an amount of time the second channel was monitored, or a combination thereof. For example, the announcement message may include or correspond to the announcement message 121 of FIG. 1.

The method 300 of FIG. 3 enables one or more devices of a data link group to independently determine a channel unusability time of a channel of the data link group by sharing channel utilization data. The channel unusability time may provide an indication of operating conditions of the channel and may enable a device to assess current channel conditions. Based on the channel unusability time, a device of the data link group may proactively scan other channels to find a better channel, may collaborate with other devices of the data link group to find an alternate channel on which to move data link group operations, or both. Proactively scanning other channels may enable the devices of the data link group to quickly find alternate channel(s). Switching to an alternate channel may reduce channel unusability time (as compared to the channel unusability time of the previous channel), thereby improving operating conditions of the data link group.

The process shown in the method 200 of FIG. 2, the method 300 of FIG. 3, or a combination thereof, may be controlled by a processing unit such as a central processing unit (CPU), a controller, a field-programmable gate array (FPGA) device, an application-specific integrated circuit (ASIC), another hardware device, firmware device, or any combination thereof. As an example, the method 200 of FIG. 2, the method 300 of FIG. 3, or a combination thereof, can be performed by one or more processors that execute instructions to determine an unusable channel time. Additionally, a first portion of one of the methods of FIGS. 2-3 may be combined with at least a second portion of another one of the methods of FIGS. 2-3. For example, a first portion of the method 200 of FIG. 2 may be combined with a second portion of the method 300 of FIG. 3.

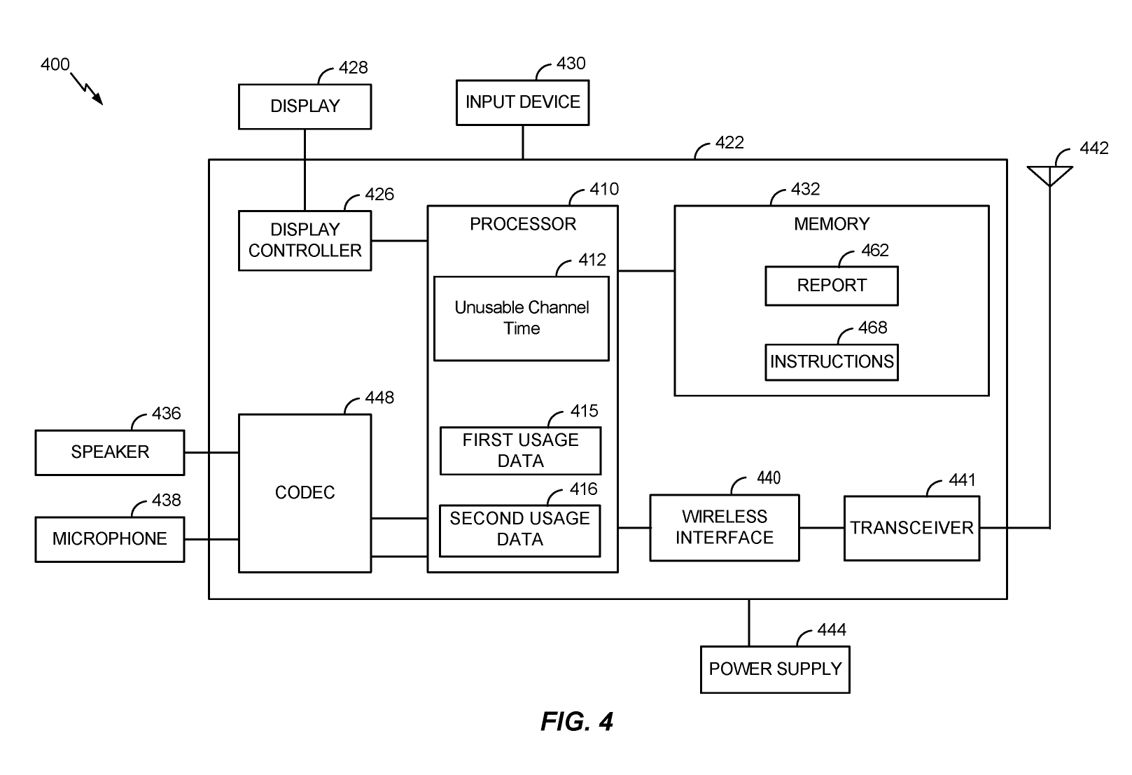

Referring to FIG. 4, a particular illustrative implementation of a wireless communication device is depicted and generally designated 400. The device 400 includes a processor 410, such as a digital signal processor, coupled to a memory 432. The device 400, or components thereof, may correspond to the devices 104-108 of FIG. 1, or components thereof.

Memory 432, such as a non-transitory computer readable medium, may include a report 462 and instructions 468. The instructions 468 may be executable by the processor 410. For example, the memory 432 may include or correspond to the memory 140 of FIG. 1. The report 462 may include or correspond to the report 132 of FIG. 1.

The processor 410 may be configured to determine unusable channel time 412 based on first usage data 415 and second usage data 416. The unusable channel time 412 may include or correspond to the unusable channel time 130. The first usage data 415 and the second usage data 416 may include or correspond to the first usage data 144 and the second usage data 122, respectively. The processor 410 may include or correspond to the processor 112 of FIG. 1.

The processor 410 may be configured to execute software (e.g., a program represented by one or more of the instructions 468) stored in the memory 432. For example, the processor 410 may be configured to operate in accordance with the method 200 of FIG. 2, the method 300 of FIG. 3, or a combination thereof. To illustrate, the processor 410 may be configured to execute the instructions 468 that cause the processor 410 to determine, at the device 400 of a data link group, the first usage data 415 of a channel of the data link group. The first usage data may be associated with a time period, such as the time period 180 of FIG. 1. The instructions 468 may further cause the processor 410 to identify the second usage data 416 of the channel of a data link group. The second usage data 416 may be received at the device 400 from another device of the data link group and may be associated with the time period. The instructions 468 may further cause the processor 410 to determine the unusable channel time 412 of the channel based on the first usage data 415 and the second usage data 416.

As another example, the processor 410 may be configured to execute the instructions 468 that cause the processor 410 to determine, at the device 400 of a data link group, the first usage data 415 of a channel of the data link group. The first usage data may be associated with a time period. The instructions 468 may further cause the processor 410 to identify the second usage data 416 of the channel of a data link group. The second usage data 416 may be received at the device 400 from another device of the data link group responsive to a query (e.g., the query 124 of FIG. 1) sent from the device 400 to the other device and may be associated with the time period. The instructions 468 may further cause the processor 410 to determine the unusable channel time 412 of the channel based on the first usage data 415 and the second usage data 416.

FIG. 4 also shows a display controller 426 that is coupled to the processor 410 and to a display 428. A coder/decoder (CODEC) 434 can also be coupled to the processor 410. A speaker 436 and a microphone 438 can be coupled to the CODEC 434. FIG. 4 also indicates that a wireless interface 440 can be coupled to the processor 410 and to an antenna 442. For example, the wireless interface 440 may be coupled to the antenna 442 via a transceiver 441. The transceiver 441 may include a transmitter (e.g., the transmitter 110), a receiver (e.g., the receiver 111), or both. The transceiver 441 may be configured to transmit one or more messages generated by the message logic 414 and to receive one or more messages transmitted to the device 400 by other devices, such as devices of the data link group.

In some implementations, the processor 410, the display controller 426, the memory 432, the CODEC 434, the wireless interface 440, and the transceiver 441 are included in a system-in-package or system-on-chip device 422. In a particular implementation, an input device 430 and a power supply 444 are coupled to the system-on-chip device 422. Moreover, in another particular implementation, as illustrated in FIG. 4, the display 428, the input device 430, the speaker 436, the microphone 438, the antenna 442, and the power supply 444 are external to the system-on-chip device 422. However, each of the display 428, the input device 430, the speaker 436, the microphone 438, the antenna 442, and the power supply 444 can be coupled to a component of the system-on-chip device 422, such as an interface or a controller.

In conjunction with one or more of the described implementations of FIGS. 1-4, a first apparatus includes means for determining first usage data at a first device of a data link group, the first usage data corresponding to a channel of the data link group and associated with a time period. For example, the means for determining the first usage data may include or correspond to the processor 112 of FIG. 1, the processor 410 programmed to execute the instructions 468 of FIG. 4, one or more other structures, devices, circuits, modules, or instructions to determine the first usage data, or any combination thereof.

The first apparatus also includes means for receiving second usage data from a second device of the data link group, the second usage data corresponding to the channel of the data link group and associated with the time period. For example, the means for receiving may include or correspond to the receiver 111 of FIG. 1, the wireless interface 440, the transceiver 441, the antenna 442, the processor 410 programmed to execute the instructions 468 of FIG. 4, one or more other structures, devices, circuits, modules, or instructions to receive the second usage data, or any combination thereof.

The first apparatus also includes means for determining an unusable channel time value of the channel based on the first usage data and the second usage data. For example, the means for determining the unusable channel time value may include or correspond to the processor 112 of FIG. 1, the processor 410 programmed to execute the instructions 468 of FIG. 4, one or more other structures, devices, circuits, modules, or instructions to determine the unusable channel time value, or any combination thereof.

In conjunction with the one or more described implementations, a second apparatus includes means for determining first usage data at a first device of a data link group, the first usage data corresponding to a channel of the data link group and associated with a time period. For example, the means for determining the first usage data may include or correspond to the processor 112 of FIG. 1, the processor 410 programmed to execute the instructions 468 of FIG. 4, one or more other structures, devices, circuits, modules, or instructions to determine the first usage data, or any combination thereof.

The second apparatus includes means for receiving second usage data from a second device of the data link group responsive to a query sent from the first device to the second device, the second usage data corresponding to the channel of the data link group and associated with the time period. For example, the means for receiving may include or correspond to the receiver 111 of FIG. 1, the wireless interface 440, the transceiver 441, the antenna 442, the processor 410 programmed to execute the instructions 468 of FIG. 4, one or more other structures, devices, circuits, modules, or instructions to receive the second usage data, or any combination thereof.

The second apparatus also includes means for determining an unusable channel time value of the channel based on the first usage data and the second usage data. For example, the means for determining the unusable channel time value may include or correspond to the processor 112 of FIG. 1, the processor 410 programmed to execute the instructions 468 of FIG. 4, one or more other structures, devices, circuits, modules, or instructions to determine the unusable channel time value, or any combination thereof.

One or more of the disclosed implementations may be implemented in a system, a device, or an apparatus, such as the device 400, that may include a communications device, a fixed location data unit, a mobile location data unit, a mobile phone, a cellular phone, a satellite phone, a computer, a tablet, a portable computer, a display device, a media player, or a desktop computer. Alternatively or additionally, the device 1300 may include a set top box, an entertainment unit, a navigation device, a personal digital assistant (PDA), a monitor, a computer monitor, a television, a tuner, a radio, a satellite radio, a music player, a digital music player, a portable music player, a video player, a digital video player, a digital video disc (DVD) player, a portable digital video player, a satellite, a vehicle or a device integrated within a vehicle, any other device that includes a processor or that stores or retrieves data or computer instructions, or a combination thereof. As another illustrative, non-limiting example, the system, the device, or the apparatus may include remote units, such as hand-held personal communication systems (PCS) units, portable data units such as global positioning system (GPS) enabled devices, meter reading equipment, or any other device that includes a processor or that stores or retrieves data or computer instructions, or any combination thereof.

Although one or more of FIGS. 1-4 may illustrate systems, apparatuses, methods, or a combination thereof, according to the teachings of the disclosure, the disclosure is not limited to these illustrated systems, apparatuses, methods, or a combination thereof. One or more functions or components of any of FIGS. 1-4 as illustrated or described herein may be combined with one or more other portions of another function or component of FIGS. 1-4. Accordingly, no single implementation described herein should be construed as limiting and implementations of the disclosure may be suitably combined without departing from the teachings of the disclosure.

Those of skill in the art would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the implementations disclosed herein may be included directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient (e.g., non-transitory) storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims.

What is claimed is:

1. An apparatus comprising:
a receiver configured to receive first usage data of a channel of a data link group, the first usage data received from a device of the data link group and associated with a time period; and
a processor configured to:
determine second usage data of the channel, the second usage data associated with the time period; and
determine an unusable channel time value of the channel based on the first usage data and the second usage data.

2. The apparatus of claim 1, wherein the processor is further configured to:
determine a first amount of time that the channel is used for data link group traffic corresponding to the data link group and used for non-data link group traffic during the time period; and
determine a second amount of time the channel is used for the data link group traffic during the time period, the second amount of time determined based on a sum of the first usage data and the second usage data, wherein the unusable channel time value is determined based on a difference between the first amount of time and the second amount of time.

3. The apparatus of claim 1, wherein the receiver is configured to receive the first usage data responsive to a query sent to the device, and wherein the time period corresponds to a time period between two discovery windows of a NAN communication channel.

4. The apparatus of claim 1, further comprising a transmitter configured to transmit data that indicates the unusable channel time value to at least one device of the data link group.

5. The apparatus of claim 1, further comprising a memory configured to store the first usage data, the second usage data, or a combination thereof.

6. The apparatus of claim 1, wherein the receiver and the processor are integrated into a mobile communication device.

7. A method for wireless communication, the method comprising:
determining, at a first device of a data link group, first usage data of a channel of the data link group, the first usage data associated with a time period;
receiving, at the first device from a second device of the data link group, second usage data of the channel of the data link group, the second usage data associated with the time period; and
determining an unusable channel time value of the channel based on the first usage data and the second usage data.

8. The method of claim 7, wherein the second usage data corresponds to an amount of data link group traffic of the data link group received via the channel by the second device during the time period, and wherein determining the first usage data comprises:
determining an amount of traffic received via the channel by the first device during the time period; and
determining an amount of traffic broadcasted via the channel by the first device during the time period.

9. The method of claim 7, wherein the second usage data corresponds to an amount of data link group traffic of the data link group transmitted by the second device via the channel during the time period, and wherein determining the first usage data comprises determining an amount of traffic transmitted by the first device via the channel during the time period.

10. The method of claim 7, further comprising transmitting the first usage data to at least one device of the data link group during a discovery window or during a time-block corresponding to the data link group, wherein the first usage data is transmitted to at least one device as a unicast message or a broadcast message.

11. The method of claim 10, further comprising:
monitoring one or more channels;
after monitoring a second channel of the one or more channels, generating a report that includes load data corresponding to the second channel, an indication of how long the second channel was monitored, or a combination thereof; and
transmitting the report to another device of the data link group during a time-block of the data link group or during a discovery window.

12. The method of claim 10, further comprising:
determining a size of a time-block of the data link group;
comparing the size to a third threshold;
in response to a determination that the size satisfies the third threshold, monitoring one or more channels;
determining a second size of a second time-block of the data link group;
comparing the second size to a fourth threshold;
in response to a determination that the second size satisfies the fourth threshold, generating a channel change announcement message; and
transmitting the channel change announcement message to at least one device of the data link group.

13. The method of claim 7, wherein the second usage data is received responsive to a query sent to the second device, and further comprising transmitting data indicating the unusable channel time value of the channel to one or more devices of the data link group.

14. The method of claim 13, further comprising sending the query to the second device during a discovery window of a neighbor aware network that includes the data link group or during a time-block of the data link group, wherein the query specifies the one or more channels to be monitored by the second device, an amount of time to monitor a particular channel of the one or more channels, or a combination thereof.

15. The method of claim 13, further comprising, after receiving the second usage data:
responsive to a second query sent to the second device of the data link group, receiving, at the first device from the second device, third usage data of the channel, the third usage data corresponding to a second time period that is subsequent to the time period; and
determining a second unusable channel time value based on the first usage data, the second usage data, and the third usage data.

16. The method of claim 7, further comprising:
receiving one or more traffic indication messages during a paging window of a time-block of the data link group;
estimating a channel utilization of the channel based on a number of traffic indication messages received during the paging window, a number of different transmitter devices of the one or more traffic indication messages, a number of receiver devices indicated by the one or more traffic indication messages, a number of devices included in the data link group, one or more parameters associated with a service provided by the data link group, a number of active communication links in the data link group, or a combination thereof; and
changing a size of one or more time-blocks of the data link group based on the estimated channel utilization.

17. The method of claim 7, further comprising:
transmitting a report request to a third device of the data link group, wherein the report request is transmitted during a discovery window of a neighbor aware network (NAN), during a paging window portion of a time-block of the data link group, or during a transmission widow portion of the time-block of the data link group;
responsive to the report request, receiving a report from the third device, the report including load data corresponding to a second channel, an indication of how long the second channel was monitored, or a combination; and
determining, based on the report, whether to switch the data link group from the channel to the second channel or whether to request additional monitoring of the second channel.

18. The method of claim 7, further comprising:
determining to switch the data link group from communicating via the channel to communicating via a second channel; and
transmitting an announcement message from the first device to one or more devices of the data link group, the announcement message including data instructing the one or more devices to switch from the channel to the second channel, indicating load conditions of the second channel, indicating an amount of time the second channel was monitored, or a combination thereof.

19. An apparatus comprising:
means for determining first usage data at a first device of a data link group, the first usage data corresponding to a channel of the data link group and associated with a time period;
means for receiving second usage data from a second device of the data link group, the second usage data corresponding to the channel of the data link group and associated with the time period; and
means for determining an unusable channel time value of the channel based on the first usage data and the second usage data.

20. The apparatus of claim 19, further comprising, means for transmitting the first usage data to at least one device of the data link group.
